(19) United States
(12) Patent Application Publication
(10) Pub. No.: US 2007/0104110 A1
(43) Pub. Date: May 10, 2007

(54) SYSTEM AND METHOD FOR TESTING A NETWORK INTERFACE CARD

(76) Inventors: De-Hua Dang, Shenzhen (CN); Xiang-Yang Zhu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,992

(22) Filed: Jun. 5, 2006

(30) Foreign Application Priority Data
Nov. 8, 2005 (CN) 200510101251.X

(51) Int. Cl. H04L 12/26

(52) U.S. Cl. 370/245; 370/252

(57) ABSTRACT

An exemplary method for testing a network interface card (104) is disclosed. The network interface card (NIC) is connected to a motherboard (102) and a test fixture (108) collectively to form a transmission loop. The method includes the steps of: enabling the NIC; creating a first data packet that includes test data; sending the first data packet via the transmission loop; receiving data from the transmission loop and storing the data as a second data packet; and determining whether the second data packet has the same data as the test data in the first data packet to determine whether the NIC functions normally. A related system is also disclosed.

### FIELD OF THE INVENTION

The present invention is generally related to systems and methods of computer tests, and more particularly, to a system and method for computer hardware devices tests.

### DESCRIPTION OF RELATED ART

Nowadays, not only may a computer assist humans on data processing, but may also be used as an entertainment system playing music or other forms of multi-media or as a tool for going on the Internet. During assembly, a computer may be installed with a plurality of various peripheral devices while it is in the assembly plant. Before the computer is shipped to a customer or a computer retailer, the computer should pass a series of tests to make sure that the computer works normally.

One of these tests is the test for network interface cards (NICs). The purpose of such test is to test functions of NICs installed in a computer. Typically, the test requires at least one test server and a plurality of test computers installed with NICs. Before the test, a physical network is required to be established by engineers. During the test, test data files are transmitted over the network through the test server and each test computer whereby to test whether the NICs are in good working condition.

However, such tests are very expensive due to the requirement that the physical network needs at least one test server and test computers. Furthermore, the test results depend much on the establishment of the physical network.

What is needed, therefore, is a method that test a network interface card more efficiently, conveniently and inexpensively.

### SUMMARY OF THE INVENTION

One embodiment provides a system for testing a network interface card (NIC). The system includes a device management module, a data packet creating module, a data packet sending module, a data packet receiving module and a determining module. The device management module is configured for enabling the network interface card. The network interface card is connected to a motherboard and a test fixture to form a transmission loop. The data packet creating module is configured for creating a first data packet that includes test data. The data packet sending module is configured for sending the first data packet via the transmission loop. The data packet receiving module is configured for receiving data from the transmission loop and storing the data as a second data packet. The determining module is configured for determining whether the second data packet has the same data as the test data in the first data packet, to determine whether the network interface card functions normally.

One embodiment provides a method for testing an NIC. The NIC is attached to a motherboard, connected to a test fixture, which makes the NIC, the motherboard and the test fixture collectively form a transmission loop. The method includes the steps of: providing a motherboard and a test fixture, both being connected to a network interface card to be tested to form a transmission loop; enabling the network interface card; creating a first data packet that comprises test data; sending the first data packet via the transmission loop; receiving data from the transmission loop and storing the data as a second data packet; and determining whether the second data packet has the same data as the test data in the first data packet, to determine whether the network interface card functions normally.

Other systems, methods, features, and advantages of the present invention will be or become apparent to one skilled in the art upon examination of the following drawings and detailed description.

### BRIEF DESCRIPTION OF THE DRAWINGS

FIG. 1 is a schematic diagram of an application environment of a system for testing a network interface card (NIC) in accordance with one preferred embodiment;

FIG. 2 is a schematic diagram of function modules of the NIC test system of FIG. 1; and

FIG. 3 is a flowchart of a method for testing an NIC in accordance with one preferred embodiment.

### DETAILED DESCRIPTION OF THE INVENTION

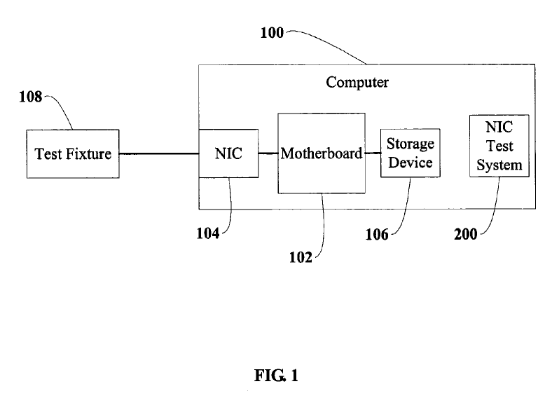

FIG. 1 is a schematic diagram of an application environment of a system for testing a network interface card (NIC) in accordance with one preferred embodiment. The application environment may typically include a computer 100 and a test fixture 108. The computer 100 may be an IBM clone personal computer (PC). Typically, the computer 100 may include a motherboard 102, a storage device 106, a central processing unit (CPU), a memory and other units or hardware, such as an audio card, a graphic accelerating card, a keyboard, a mouse, and so on. However, in order to describe the preferred embodiment concisely, these units are not shown in the drawings.

The motherboard 102 may be a typical main board that can be configured onto a computer. The motherboard 102 typically provides a plurality of interfaces (or ports) for attachment of various peripheral devices or hardware; for example, providing a CPU socket for the attachment of a CPU, providing a memory slot for the attachment of a memory. In the preferred embodiment, the motherboard 102 further provides a storage interface for an attachment of the storage device 106 and a network interface for an attachment of a network interface card (NIC) 104. The NIC 104 is also known as network adapter.

The storage device 106 may be an internal storage of the computer 100, such as a hard disk or a floppy disk, or an outer usage storage, such as a compact disk, a flash memory or the like.

Furthermore, the test fixture 108 typically consists of an RJ-45 connector and at least a CAT5 cable. The RJ-45 connector is commonly used for network cabling and for telephony applications. The RJ-45 connector can also be used for serial connections in special cases. Although used for a variety of purposes, the RJ-45 connector is probably most commonly used for 10Base-T and 100Base-TX Ethernet connections, such as usage in the preferred embodiment. As known, CAT5 is an Ethernet cable standard defined by the Electronic Industries Association and Telecommunications Industry Association (commonly known as EIA/TIA). CAT5 is the 5th generation of twisted pair Ethernet cabling and the most popular of all twisted pair cables in use today, also known as Category 5.

In the embodiment, the test fixture 108 is attached to the NIC 104, this makes the motherboard 102, the NIC 104 and the test fixture 108 to collectively form a transmission loop. Test files or data packets can be transmitted in the transmission loop. The transmission loop is partially formed by connecting the first pin and the third pin of the RJ-45 connector, and connecting the second pin and the sixth pin of the RJ-45 connector. The first and the second pins function as transmitting pins, and the third and the sixth pins function as receiving pins.

Moreover, an NIC test system 200 is installed on the computer 100 to assist the computer 100 to test whether the NIC 104 functions normally. The NIC test system 200 is typically an application software or a combination thereof executable by a typical computer.

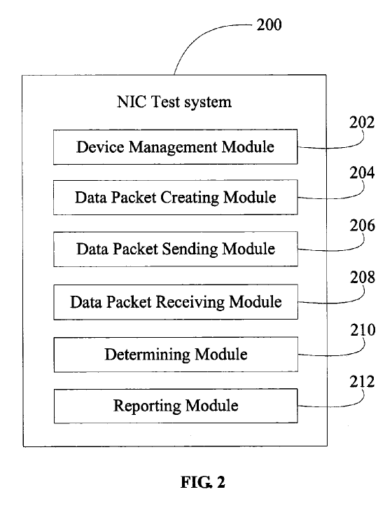

FIG. 2 is a schematic diagram of function modules of the NIC test system 200. The NIC test system 200 mainly includes a device management module 202, a data packet creating module 204, a data packet sending module 206, a data packet receiving module 208, a determining module 210 and a reporting module 212.

The device management module 202 is mainly configured for enabling a network interface card (for example, the NIC 104) that is connected to a motherboard (for example, the motherboard 104) and a test fixture (for example, the test fixture 108), and for disabling the NIC 104 after the test. The device management module 202 is further configured for obtaining a device identification of the NIC 104, obtaining the media access control (MAC) address of the NIC 104, and obtaining a corresponding network driver interface specification (NDIS) handle. The NDIS handle is required for enabling the NIC 104, like that a ticket is required for boarding on a bus.

A MAC address of an NIC is a hardware address/physical address that uniquely identifies the NIC. One MAC address matches a unique corresponding NIC in the world. A MAC address typically consists of 48 bits of binary numbers, or 12 bits of hex numbers, for example, 00-D0-09-A1-D7-B7. NDIS developed by Microsoft and 3COM is a windows device driver interface that enables a single NIC to support multiple protocols. The device management module 202 uses the device identification, MAC address of the NIC 104 and the corresponding NDIS handle to enable the NIC 104.

The data packet creating module 204 is mainly configured for creating a first data packet. The first data packet is stored in the storage device 106. The first data packet includes a source MAC address, a destination MAC address, test data and a definition of a data frame type of the test data. In the embodiment, the source MAC address is the same as the MAC address of the NIC 104, and the destination MAC address may be any acceptable address, typically, the broadcast address: FFFF FFFF FFFF. The test data can be any type of data, such as a typical text data, or even a string of bits.

The data packet sending module 206 is mainly configured for sending a whole first data packet via the transmission loop. The test data in the first data packet are sent from the source MAC address to the destination MAC address defined in the first data packet. In particular, the test data are divided into a plurality of data frames, the types of data frames are defined in the first data packet before being sent, and each data frame is defined to be sent from the source MAC address to the destination MAC address. In the preferred embodiment, the data frames are sent from the NIC 104, transmitted through the test fixture 108, and finally back to the NIC 104.

The data packet receiving module 208 is mainly configured for receiving data from the transmission loop, and storing the data into the storage device 106 as a second data packet. In particular, the data packet receiving module 208 receives data frames from the transmission loop through the NIC 104, and stores and combines the data frames that have the same source MAC address and destination MAC address into the storage device 106 as a second data packet.

The determining module 210 is mainly configured for determining whether the second data packet has the same data as the test data in the first data packet, so as to determine the test result of whether the NIC 104 functions normally. Specifically, the test result denotes that the NIC 104 functions normally if the second data packet has the same data as the test data in the first data packet; or the test result denotes that the NIC 104 does not function normally if the second data packet does not have the same data as the test data in the first data packet.

The reporting module 212 is mainly configured for reporting the test result. The test result may be shown on a monitor or printed by a printer, or in other suitable manners.

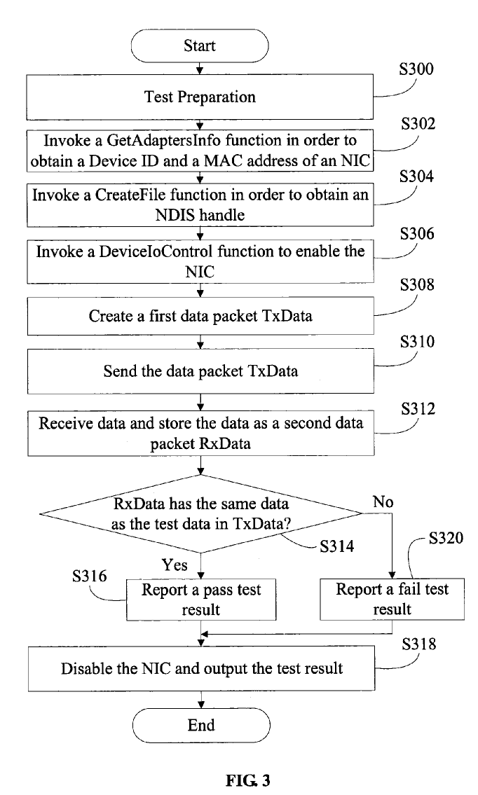

FIG. 3 is a flowchart of a method for testing an NIC in accordance with one preferred embodiment. Step S300 includes test preparations that include: preparing a test fixture 108 by utilizing the RJ-45 connector and at least one CAT5 cable; connecting the test fixture 108 to the NIC 104, and connecting the NIC 104 to the motherboard 102 so as to form the transmission loop, and executing the NIC test system 200 in the computer 100. Test files or data packets can be transmitted in the transmission loop. The transmission loop is partially formed by connecting the first pin and the third pin of the RJ-45 connector, and connecting the second pin and the sixth pin of the RJ-45 connector. The first and second pins function as transmitting pins, and the third and sixth pins function as receiving pins.

In step S302, the device management module 202 invokes a GetAdaptersInfo function to obtain the device identification and the MAC address of the NIC 104. The GetAdaptersInfo function is a typical function of the standard software development kit (SDK) issued and provided by Microsoft Corporation. It should be noted that, in an alternative embodiment, the GetAdaptersInfo function as well as other functions below used in the preferred embodiment can be replaced with other functions or application programs that achieves the same or similar objective. That is, the execution of the test method does not rely on SDK.

In step S304, the device management module 202 invokes a CreateFile function of SDK to obtain a corresponding NDIS handle. In step S306, the device management module 202 invokes a DeviceIoControl function of SDK to enable the NIC 104 according to the device identification and the MAC address of the NIC 104 and the corresponding NDIS handle.

In step S308, the data packet creating module 204 creates a first data packet (herein named and referred to as TxData). TxData is stored in the storage device 106. TxData includes the source MAC address, the destination MAC address, test data, and a definition of the data frame type of the test data. In the preferred embodiment, the source MAC address is the same as the MAC address of the NIC 104, and the destination MAC address may be any acceptable address, typically, the broadcast address: FFFF FFFF FFFF. The test data can be any type of data, such as a typical text data, or even a string of characters or numbers.

In step S310, the data packet sending module 206 sends TxData via the transmission loop. In particular, the data packet sending module 206 divides the test data of TxData into a plurality of data frames with the type defined in TxData, and sends each data frame from the source MAC address to the destination MAC address. In the preferred embodiment, the data frames are sent from the NIC 104, transmitted through the test fixture 108, and finally back to the NIC 104.

In step S312, the data packet receiving module 208 receives data from the transmission loop, and stores the data into the storage device 106 as the second data packet (herein named and referred to as RxData). In particular, the data packet receiving module 208 receives data frames from the transmission loop through the NIC 104, and stores and combines the data frames that have the same source MAC address and destination MAC address into the storage device 106 as the second data packet RxData.

In step S314, the determining module 210 determines whether RxData has the same data as the test data in TxData, so as to determine whether the network interface card functions normally.

If RxData has the same data as the test data in TxData, in step S316, the reporting module 212 reports a passed test result denoting that the NIC 104 functions normally. Otherwise, if RxData does not have the same data as the test data in TxData, in step S320, the reporting module 212 reports a failed test result denoting that the NIC 104 does not function normally.

In step S318, the device management module 202 disables the NIC 104, and the reporting module 212 outputs the test result on a monitor, a printer, or in other suitable manners.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for testing a network interface card, the system comprising:
a device management module configured for enabling the network interface card, the network interface card being connected to a motherboard and a test fixture to form a transmission loop;
a data packet creating module configured for creating a first data packet that comprises test data;
a data packet sending module configured for sending the first data packet via the transmission loop;
a data packet receiving module configured for receiving data from the transmission loop and storing the data as a second data packet; and
a determining module configured for determining whether the second data packet has the same data as the test data in the first data packet, to determine whether the network interface card functions normally.

2. The system according to claim 1, wherein the device management module is further configured for:
obtaining a device identification of the network interface card;
obtaining the media access control address of the network interface card; and
obtaining a network driver interface specification handle.

3. The system according to claim 2, wherein the first data packet further comprises a source media access control address, a destination media access control address, and a definition of a data frame type.

4. The system according to claim 3, wherein the source media access control address is the same as the media access control address of the network interface card.

5. The system according to claim 2, wherein the destination media access control address is a broadcast address: FFFF FFFF FFFF.

6. The system according to claim 1, wherein the device management module is further configured for disabling the network interface card.

7. The system according to claim 1, wherein the test fixture comprises an RJ-45 connector and a CAT5 cable.

8. The system according to claim 7, wherein the transmission loop is formed by connecting the first pin and the third pin of the RJ-45 connector, and connecting the second pin and the sixth pin of the RJ-45 connector.

9. The system according to claim 1, further comprising a reporting module for reporting a test result denoting that:
the network interface card functions normally if the second data packet has the same data as the test data in the first data packet; or
the network interface card does not function normally if the second data packet does not have the same data as the test data in the first data packet.

10. A method for testing a network interface card, the method comprising:
providing a motherboard and a test fixture, both of which are connected to a network interface card to form a transmission loop;
enabling the network interface card;
creating a first data packet that comprises test data;
sending the first data packet via the transmission loop;
receiving data from the transmission loop and storing the data as a second data packet; and
determining whether the second data packet has the same data as the test data in the first data packet, to determine whether the network interface card functions normally.

11. The method according to claim 10, further comprising:
obtaining a device identification of the network interface card;
obtaining a media access control address of the network interface card; and
obtaining a network driver interface specification handle.

12. The method according to claim 11, wherein the creating step comprises:
setting a source media access control address;
setting a destination media access control address; and
defining a data frame type.

13. The method according to claim 12, wherein the set source media access control address is the same as the media access control address of the network interface card.

14. The method according to claim 12, wherein the destination media access control address is a broadcast address: FFFF FFFF FFFF.

15. The method according to claim 10, further comprising a step of disabling the network interface card.

16. The method according to claim 10, wherein the test fixture comprises an RJ-45 connector and a CAT5 cable.

17. The method according to claim 16, wherein the transmission loop is formed by connecting the first pin and the third pin of the RJ-45 connector, and connecting the second pin and the sixth pin of the RJ-45 connector.

18. The method according to claim 10, further comprising a step of reporting a test result denoting that:
the network interface card functions normally if the second data packet has the same data as the test data in the first data packet; or
the network interface card does not function normally if the second data packet does not have the same data as the test data in the first data packet.
